(19) United States
(12) Patent Application Publication
(10) Pub. No.: US 2004/0187616 A1
(43) Pub. Date: Sep. 30, 2004

(54) Bellows lateral stiffness adjustment

(76) Inventors: Douglas C. Watson, Campbell, CA (US); Andrew J. Hazelton, San Carlos, CA (US)

Correspondence Address: RITTER, LANG & KAPLAN, 12930 SARATOGA AE. SUITE D1, SARATOGA, CA, 95070, US

(21) Appl. No.: 10/400,707

(22) Filed: Mar. 26, 2003

(51) Int. Cl. F16J 15/50

(52) U.S. Cl. 74/18.2

(57) ABSTRACT

Methods and apparatus for adjusting the lateral stiffness of a bellows are disclosed. According to one aspect of the present invention, a bellows assembly that supports a load includes a first bellows that has an adjustable length. The first bellows also has a first end and a second end, with the first end being substantially coupled to the load. The bellows assembly, which is coupled to the second end of the first bellows, also includes a mechanism that adjusts the length of the first bellows.

### BACKGROUND OF THE INVENTION

1. Field of Invention

The present invention relates generally to semiconductor processing equipment. More particularly, the present invention relates to a mechanism which enables the lateral stiffness of an air bellows to be adjusted to reduce the transmissibility of vibrations through the air bellows.

2. Description of the Related Art

For precision instruments such as photolithography machines which are used in semiconductor processing, factors which affect the performance, e.g., accuracy, of the precision instrument generally must be dealt with and, insofar as possible, eliminated. When the performance of a precision instrument is adversely affected, as for example by vibrations, products formed using the precision instrument may be improperly formed and, hence, function improperly. For instance, a photolithography machine which is subjected to excessive vibrations may cause an image projected by the photolithography machine to move, and, as a result, be aligned incorrectly on a projection surface such as a semiconductor wafer surface.

Scanning stages such as wafer scanning stages and reticle scanning stages are often used in semiconductor fabrication processes, and may be included in various photolithography and exposure apparatuses. Wafer scanning stages are generally used to position a semiconductor wafer such that portions of the wafer may be exposed as appropriate for masking or etching. Reticle scanning stages are generally used to accurately position a reticle or reticles for exposure over the semiconductor wafer. Patterns are generally resident on a reticle, which effectively serves as a mask or a negative for a wafer. When a reticle is positioned over a wafer as desired, a beam of light or a relatively broad beam of electrons may be collimated through a reduction lens, and provided to the reticle on which a thin metal pattern is placed. Portions of a light beam, for example, may be absorbed by the reticle while other portions pass through the reticle and are focused onto the wafer.

Within a photolithography apparatus, vibrations may be particularly problematic, especially when the vibrations are excited to uncontrollable levels in components of the apparatus such as a wafer table. Vibrations which affect the wafer table often cause relatively significant stage control problems which, in turn, may adversely affect the accuracy with which an overall photolithography process may be performed.

In order to reduce the effect of vibrations, systems such as an active vibration isolation system (AVIS) may be used in an effort to substantially isolate components of a photolithography apparatus from surfaces which may transmit vibrations, e.g., ground surfaces. Components of a photolithography apparatus such as a wafer table may also be isolated through the use of an air bellows or a plurality of air bellows, as described in PCT Application No. PCT/US00/10831, filed Apr. 21, 2000, which is incorporated herein by reference in its entirety.

An air bellows is typically configured such that a stiffness, e.g., a lateral stiffness, associated with the air bellows varies depending upon the length of the air bellows. In other words, the lateral stiffness of an air bellows is a function of the length of the air bellows. As will be appreciated by those skilled in the art, if an air bellows is effectively modeled as a beam with a length L_{b}, and an equivalent modulus of elasticity and inertia term (EI)_{equiv}, the stiffness k of the air bellows may generally be expressed as follows:

$$k = \frac{12 {( EI )}_{equiv}}{{L}_{b}^{3}}$$

When a load such as a wafer table is supported by a bellows, pressurized air within the bellows effectively supports the load. FIG. 1 is a diagrammatic representation of a load supported by a bellows. A bellows 102 is generally attached on one end to a ground surface 110 and attached on another end to a load 106. Pressurized air within bellows 102 acts on load 106, e.g., on a surface area associated with load 106, to provide a force that supports load 106.

Bellows 102 or, more specifically, the sides of bellows 102 have a mechanical stiffness. When the mechanical stiffness of bellows 102 and, hence, a lateral stiffness of bellows 102, is relatively high, then vibrations may be transmitted from ground surface 110 through the sides of bellows 102 to load 106. When the vibration transmissibility is such that significant vibrations are transmitted through bellows 102, then load 106 may be affected by the vibrations. When load 106 is a part of a photolithography apparatus such as a wafer table, any vibrations experienced by load 106 may cause the accuracy with which the photolithography apparatus operates to be compromised.

As shown in FIG. 2, ground vibrations 218 may be transmitted to a bellows 222 which is typically attached to a ground. Since bellows 222 is typically attached to a ground, ground vibrations are often substantially directly transmitted to bellows 222. When bellows 222 has a relatively high lateral stiffness, then bellows 222 effectively transmits vibrations to a load 226 which is attached to bellows 222. In other words, when the lateral stiffness of bellows 222 is relatively high, then the vibration transmissibility of bellows 222 is such that ground vibrations 218 may effectively be transmitted through the sides of bellows 222 to load 226.

When the lateral stiffness of a bellows, e.g., bellows 102 of FIG. 1, is relatively low, then the vibration transmissibility of the bellows is typically relatively low. As such, when a bellows is selected for use with a load, a bellows with an appropriately low lateral stiffness for the load may be selected for use with the load. However, if the load on the bellows shifts or otherwise changes, then the lateral stiffness of the bellows may no longer be relatively low with respect to the load. When the lateral stiffness of the bellows is no longer considered to be relatively low with respect to the load, significant vibrations such as ground vibrations may be transmitted through the bellows to the load.

Therefore, what is needed is a system and a method which enables the lateral stiffness of a bellows to be adjusted. More specifically, what is desired is an adjustable bellows with a lateral stiffness that may be tuned to compensate for changes to a load supported by the bellows such that vibration transmissibility through the bellows may be substantially minimized.

### SUMMARY OF THE INVENTION

The present invention relates to a method and an apparatus for adjusting the lateral stiffness of a bellows by adjusting the length of the bellows. According to one aspect of the present invention, a bellows assembly that supports a load includes a first bellows that has an adjustable length. The first bellows also has a first end and a second end, with the first end being substantially coupled to the load. The bellows assembly, which is coupled to the second end of the first bellows, also includes a mechanism that adjusts the length of the first bellows.

In one embodiment, the bellows assembly also includes a second bellows that has a first end which is coupled to the mechanism and a second end that is coupled to a ground surface. In such an embodiment, the mechanism may include a plate and a driver. The plate is coupled to the second end of the first bellows and the first end of the second bellows, while the driver drives the plate to adjust the length of the first bellows.

An air bellows, which may be used as a support element for a component of a photolithography apparatus or as a vibration isolation system for the component, contains pressurized air which acts over an area of a component body to provide a force that supports the component body or load. In order for the transmissibility of vibrations through the bellows to the component body to be reduced, the bellows preferably has a low lateral stiffness. Since the distribution of the load supported by the component body may be uncertain or may change over time, the ability to adjust the lateral stiffness of the bellows enables the bellows to be configured to reduce vibration transmissibility even when the load distribution of the component body changes. Changing the length of the air bellows enables the lateral stiffness of the bellows to be adjusted and, as a result, enables vibration transmissibility through the bellows to the component body to be substantially minimized.

According to another aspect of the present invention, a bellows assembly which supports a load includes a first bellows and a mechanism. The first bellows has an adjustable lateral stiffness, as well as a first end that is coupled to the load. The mechanism adjusts the lateral stiffness of the first bellows, which is coupled to the mechanism. In one embodiment, the mechanism adjusts the lateral stiffness of the first bellows by altering at least one of a mechanical stiffness of the first bellows, an internal pressure of the first bellows, and a length of the first bellows.

In another embodiment, the mechanism includes a first block that is coupled to the second end of the first bellows and a second block that is in contact with a ground surface. In such an embodiment, the mechanism further includes a drive mechanism that drives the second block substantially between the ground surface and the first block to alter the lateral stiffness of the first bellows.

According to still another aspect of the present invention, a method for adjusting a lateral stiffness of a bellows assembly which isolates a load from a first surface includes identifying the lateral stiffness of a first bellows of the assembly. The method also includes determining when the lateral stiffness of the first bellows is acceptable, and adjusting the lateral stiffness of the first bellows using the mechanism when it is determined that the lateral stiffness of the first bellows is not acceptable. In one embodiment, adjusting the lateral stiffness of the first bellows includes adjusting a length of the first bellows between the load and the first surface.

These and other advantages of the present invention will become apparent upon reading the following detailed descriptions and studying the various figures of the drawings.

### BRIEF DESCRIPTION OF THE DRAWINGS

The invention may best be understood by reference to the following description taken in conjunction with the accompanying drawings in which:

FIG. 1 is a diagrammatic representation of a load supported by a bellows.

FIG. 2 is a diagrammatic block diagram representation which illustrates how ground vibrations may be transmitted through a bellows to a load supported on the bellows.

FIG. 3a is a diagrammatic representation of a length-adjustable bellows assembly with an adjustment plate in accordance with an embodiment of the present invention.

FIG. 3b is a diagrammatic representation of a length-adjustable bellows assembly, i.e., length-adjustable bellows assembly 300 of FIG. 3a, with a compressed top bellows in accordance with an embodiment of the present invention.

FIG. 4a is a diagrammatic representation of a load which is supported by a plurality of length-adjustable bellows in accordance with an embodiment of the present invention.

FIG. 4b is a diagrammatic representation of a plurality of length-adjustable bellows which are coupled to a single adjustment plate in accordance with an embodiment of the present invention.

FIG. 5 is a diagrammatic representation of a length-adjustable bellows assembly which includes a bellows and a vertically adjustable mechanism which contains pressurized air in accordance with an embodiment of the present invention.

FIG. 6a is a diagrammatic representation of a wedge-driven length-adjustable bellows assembly in accordance with an embodiment of the present invention.

FIG. 6b is a diagrammatic representation of a wedge-driven length-adjustable bellows assembly, i.e., bellows assembly 600 of FIG. 6a, when the bellows of the bellows assembly is substantially compressed in accordance with an embodiment of the present invention.

FIG. 7 is process flow diagram which illustrates the steps associated with a first method for statically adjusting the lateral stiffness of a bellows in accordance with an embodiment of the present invention.

FIG. 8 is process flow diagram which illustrates the steps associated with a second method for statically adjusting the lateral stiffness of a bellows in accordance with an embodiment of the present invention.

FIG. 9 is a process flow diagram which illustrates the steps associated with a first method of dynamically adjusting the lateral stiffness of a bellows in accordance with an embodiment of the present invention.

FIG. 10 is a process flow diagram which illustrates the steps associated with a second method of dynamically adjusting the lateral stiffness of a bellows which includes measuring a load on the bellows in accordance with an embodiment of the present invention.

FIG. 11 is a diagrammatic representation of a photolithography apparatus in accordance with an embodiment of the present invention.

FIG. 12 is a process flow diagram which illustrates the steps associated with fabricating a semiconductor device in accordance with an embodiment of the present invention.

FIG. 13 is a process flow diagram which illustrates the steps associated with processing a wafer, i.e., step 1304 of FIG. 12, in accordance with an embodiment of the present invention.

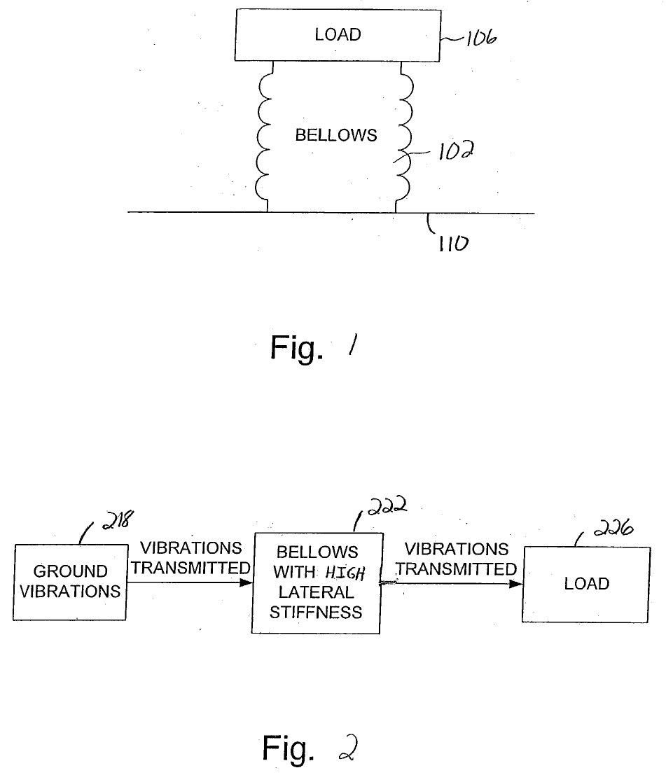

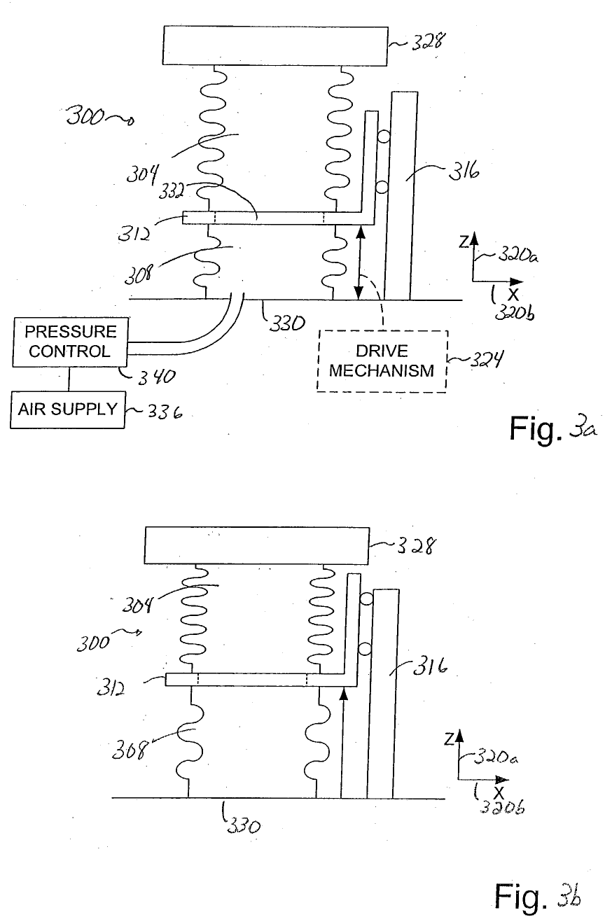

### DETAILED DESCRIPTION OF THE EMBODIMENTS

When the lateral stiffness of a bellows which supports a load or a body is considered to be relatively low, then the transmissibility of vibrations through the bellows is typically relatively low. Hence, significant vibrational energy is generally not transmitted through the bellows to the supported load when a bellows with a suitable lateral stiffness is selected to support the load. Uncertainties in the magnitude of a load, e.g., uncertainties caused by a shifting of the load, as well as any uncertainties in the mechanical stiffness of a bellows and any uncertainties in the amount of internal pressure in the bellows may lead to a bellows with an inadequate lateral stiffness being used to support a load. As a result, relatively significant vibrations such as ground vibrations may be transmitted through the bellows to the load.

By allowing the lateral stiffness of a bellows to be adjusted, uncertainties associated with the bellows or a load supported on the bellows may effectively be compensated for. For example, when it is determined that the lateral stiffness of a bellows is such that vibration transmissibility through the bellows is too high, then the lateral stiffness of the bellows may be adjusted to a lower level in order to reduce the vibration transmissibility through the bellows.

In general, the lateral stiffness of a bellows may be a function of the vertical length of the bellows, an internal air pressure of the bellows, and the mechanical stiffness of the bellows, e.g., the lateral stiffness of the bellows when there is effectively no air pressure in the bellows. It should be appreciated that the internal air pressure of the bellows typically depends upon the magnitude of the load that is to be supported on the bellows, while the mechanical stiffness of the bellows is generally a design or a manufacturing parameter of the bellows. As such, in order to adjust the lateral stiffness of the bellows, the vertical length of the bellows may be adjusted.

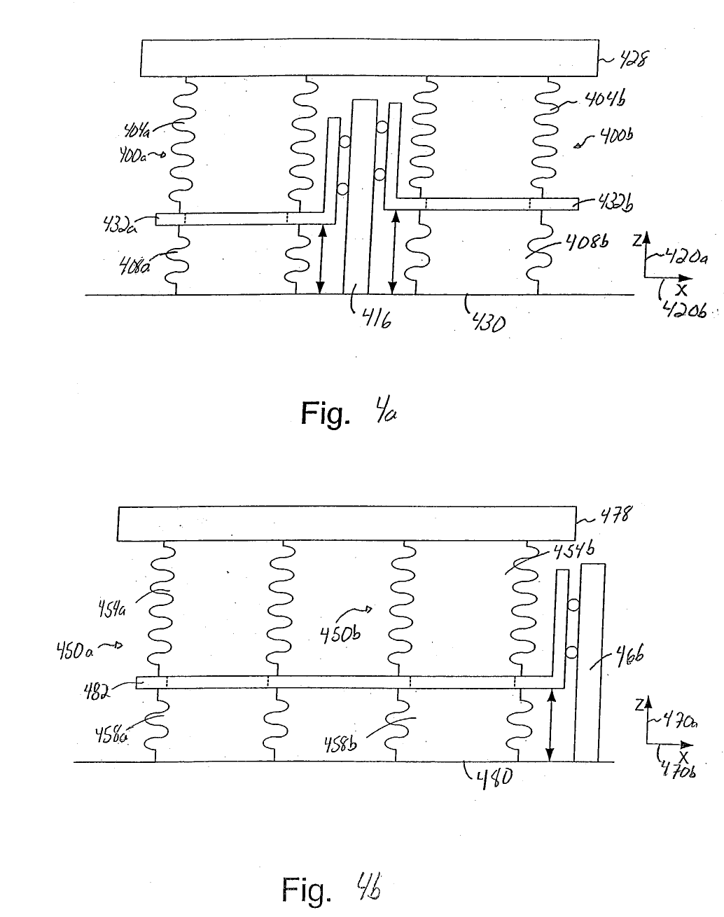

FIG. 3a is a diagrammatic representation of a length-adjustable bellows in accordance with an embodiment of the present invention. A length-adjustable bellows assembly 300, or a bellows assembly with a lateral stiffness which may be adjusted, includes a top bellows 304 and a bottom bellows 308. Top bellows 304 and bottom bellows 308 may be formed from substantially any suitable material, as for example rubber, nickel, stainless steel, or Teflon. Suitable bellows include, but are not limited to, bellows available from Servometer of Cedar Grove, N.J.

Bellows assembly 300 also includes an adjusting surface or plate 312 which is at least partially positioned between top bellows 304 and bottom bellows 308. As shown, adjusting plate 312 is interfaced with a surface 316 which cooperates with adjusting plate 312 to effectively guide adjusting plate 312 in a z-direction 320a when a drive mechanism 324 drives or otherwise moves adjusting plate 312 along surface 316 in z-direction 320a. In one embodiment, surface 316 may include a track (not shown) which enables adjusting plate 316 to be substantially guided. Drive mechanism 324 may generally include substantially any suitable motor or lead screw assembly which uses a track, that is suitable for supporting a load 328 and adjusting the respective lengths of top bellows 304 and bottom bellows 308 in z-direction 320a by adjusting the height of adjusting plate 312 relative to a ground surface 330.

Adjusting plate 312 is generally coupled to both top bellows 304 and bottom bellows 308 such that when adjusting plate 312 is moved in z-direction 320a to extend the length of top bellows 304, the length of bottom bellows 308 is shortened. On the other hand, as shown in FIG. 3b, when adjusting plate 312 is driven “upwards,” or in a positive z-direction 320a, top bellows 304 may effectively compress while bottom bellows 308 effectively extends. An opening 332 defined within adjusting plate enables air, which maybe provided by an air supply 336 through a pressure control valve 340 or similar device, to flow relatively freely between top bellows 304 and bottom bellows 308. It should be appreciated that any force on load 328 substantially created by a pressure associated with air within bellows assembly 300 is typically much less than a force imparted on load 328 as a result of the mechanical stiffness of top bellows 304.

Top bellows 304, in addition to being coupled to adjusting plate 312, is also coupled or attached to load 328, while bottom bellows 308 is coupled to adjusting plate 312 and a surface such as ground surface 330. Air pressure typically acts between load 328 and ground surface 330 due to the existence of opening 332. As such, the lateral stiffness of bellows assembly 300 is substantially dependent upon the length, i.e., the length in z-direction 320a, of top bellows 304. In general, the length of top bellows 304 may effectively be changed substantially without carrying load 328. That is, it is typically unnecessary to lift load 328 while the length of top bellows 304 is being adjusted by driving adjusting plate 312 in z-direction 320a.

In one embodiment, the lateral stiffness of top bellows 304 may be a function of the mechanical stiffness of top bellows 304, e.g., the lateral stiffness of top bellows 304 when no air pressure is applied within top bellows 304, an axial force applied on top bellows 304, and the length of top bellows 304 as measured in z-direction 320a. As described in co-pending U.S. patent application No. ______ (Atty. Docket No. PA0-470), filed ______, entitled “Air Mount With Low Lateral Stiffness for Variable Loads,” which is incorporated herein by reference in its entirety, the lateral stiffness of top bellows 304 which supports a load may be expressed as follows:

$${k}_{xy} = \frac{\sqrt{\frac{12 \cdot F}{{k}_{xy0} \cdot {L}_{b}^{3}}} F}{2 \cdot tan ( \frac{\sqrt{\frac{12 \cdot F}{{k}_{xy0} \cdot {L}_{b}^{3}}} Lb}{2} ) - \sqrt{\frac{12 \cdot F}{{k}_{xy0} \cdot {L}_{b}^{3}}} Lb}$$

where k_{xy} is the lateral stiffness of top bellows 304, k_{xy0} is the lateral stiffness of top bellows 304 when no pressurized air is present within top bellows 304, F is the axial force applied on top bellows 304 or the force that is to be supported by pressurized air in top bellows 304, and L_{b} is the length of top bellows 304. As such, for a given axial load and lateral stiffness when no pressurized air is present within top bellows 304, a suitable length of top bellows 304 may be determined so that a desired or target lateral stiffness for top bellows 304 may be achieved.

Load 328 may generally be any load, as for example a load which is associated with a photolithography apparatus such as a wafer table or a significant portion of an overall photolithography apparatus. In general, the size of bellows assembly 300 may vary depending upon the size of load 328, or depending upon the requirements of a particular application. For instance, if load 328 is a load associated with a wafer table, then a length of top bellows 304 in z-direction 320a may be relatively small, e.g., approximately 10 millimeters (mm), while a diameter of bellows assembly 300 in an x-direction 320b may also be relatively small, e.g., approximately 10 mm. Alternatively, if load 328 is a load associated with substantially an entire photolithography apparatus or a significant portion of the photolithography apparatus, then a length of top bellows 304 in z-direction 320 and a diameter of bellows assembly 300 in x-direction 320b may be relatively large, as for example in the range of approximately 200 mm to approximately 300 mm. Since it is generally not necessary to lift or otherwise support load 328 while the length of top bellows 304 is being adjusted, bellows assembly 300 is well-suited for use when load 328 is relatively large.

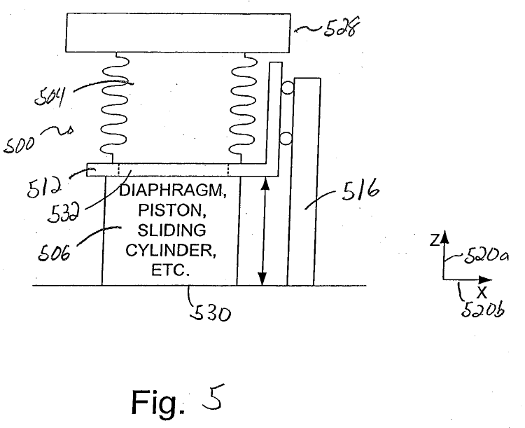

When a load supported on a length-adjustable bellows assembly or a bellows assembly with an adjustable lateral stiffness such as bellows assembly 300 is large, more than one bellows assembly may be used to substantially support the load. Using more than one bellows assembly may generally enable a larger load to be supported. FIG. 4a is a diagrammatic representation of a load which is supported by a plurality of length-adjustable bellows in accordance with an embodiment of the present invention. A load 428 is supported on two bellows assemblies 400, each of which includes a top bellows 404 that is substantially attached to load 428 and a bottom bellows 408 that is substantially attached to a ground surface 430. Each bellows assembly 400 is similar to bellows assembly 300 of FIG. 3a. Top bellows 404a and bottom bellows 408a of first bellows assembly 400a are coupled to an adjusting plate 432a, while top bellows 404b and bottom bellows 408b of second bellows assembly 400b are coupled to an adjusting plate 432b.

In the described embodiment, adjusting plates 432 cooperate with a surface 416 to enable the lengths of top bellows 404 to be adjusted substantially independently with respect to a z-direction 420a. It should be appreciated, however, that separate surfaces may instead be interfaced with each adjusting plate 432 to enable lengths of top bellows 404 to be adjusted. In order to enable the length of top bellows 404a to be altered substantially independently from the length of top bellows 404b, each adjusting plate 432 is driven independently. By way of example, each adjusting plate 432 may be driven by separate drive mechanisms which, for ease of illustration, have not been illustrated.

If load 428 is unevenly balanced, in order to substantially minimize vibration transmissibility through bellows assemblies 400, the lateral stiffness associated with top bellows 404b may be less than the lateral stiffness associated with top bellows 404a. As such, the length of top bellows 404b in z-direction 420a may be less than the length of bellows 404a in z-direction 420, as shown. In other words, adjusting plates 432 may be driven such that the length of top bellows 404a differs from the length of top bellows 404b.

In lieu of substantially independently adjusting bellows assemblies 400 which support load 428 in order to effectively balance load 428 such that vibration transmissibility through bellows assemblies 400 is low, bellows assemblies 400 may instead be adjusted such that both top bellows 404 have substantially the same length. That is, length adjustments to top bellows 404 maybe made based upon an average load on each bellows assembly 400 such that the length of each top bellows 404 is essentially the same. When the lengths of top bellows 404 are to be adjusted such that the lengths are substantially equal at all times, a single drive mechanism may be used to drive top bellows 404. Alternatively, an adjustment plate may be used to adjust the lengths instead of separate adjustment plates 432.

With reference to FIG. 4b, a load which is supported by a plurality of bellows assemblies which are coupled to a single adjustment plate will be described in accordance with an embodiment of the present invention. A load 478 is supported on bellows assemblies 450, which each include a top bellows 454 and a bottom bellows 458. Top bellows 454a and top bellows 454b are both substantially attached to load 478 at one end and to an adjusting plate 482 at another end, while bottom bellows 458a and bottom bellows 458b are both substantially attached to adjusting plate 458 at one end and to a ground surface 480 at another end.

Adjusting plate 482 cooperates with a surface 466 to enable a drive mechanism (not shown) to drive adjusting plate 482 along a z-direction 470 such that the length of top bellows 454a and the length of top bellows 454b may be adjusted and, hence, such that the lateral stiffness of each bellows assembly 450 may be altered. Since adjusting plate 482 is coupled to both bellows assembly 450a and bellows assembly 450b, when bellows assembly 450a is substantially the same as bellows assembly 450b, when adjusting plate 482 is moved in z-direction 470a, the length of top bellows 454a and the length of top bellows 454b are adjusted by substantially the same amount. In other words, length adjustments made to top bellows 454a and top bellows 454b are approximately the same, as the length of top bellows 454a and the length of top bellows 454b are effectively not adjusted separately.

In general, a bellows assembly such as bellows assembly 300 of FIG. 3 may include both a top bellows and a bottom bellows. It should be appreciated, however, that in lieu of a bottom bellows, a bellows assembly may instead include substantially any suitable mechanism which has a vertical adjustment capability, i.e., may be adjustable along a z-direction, and is suitable for containing pressurized air. FIG. 5 is a diagrammatic representation of a length-adjustable bellows assembly which includes a bellows and a vertically adjustable mechanism which contains pressurized air in accordance with an embodiment of the present invention. A bellows assembly 500 which supports a load 528 includes a bellows 504 and a vertically adjustable mechanism 506. An adjustment plate 512, which cooperates with a surface 516 and a drive mechanism (not shown) to alter the length of bellows 504 in a z-direction 520a, is coupled to bellows 504 and to mechanism 506. Mechanism 506 is also generally coupled to a ground surface 530.

In general, air, e.g., pressurized air provided by a pressurized air source (not shown), is contained within bellows assembly 500. As such, mechanism 506 may or many not be arranged to have the capability to contain the air, and to enable air to circulate between mechanism 506 and bellows 504 through an opening 532 defined in adjustment plate 532. Additionally, as previously mentioned, mechanism 506 is also arranged to have a length that is adjustable along z-direction 520a. While the configuration or structure of mechanism 560 may vary widely, mechanism 506 is generally a structure which has a relatively high stiffness. By way of example, mechanism 506 may have stiffness characteristics that are substantially greater than the stiffness characteristics of bellows 504. Suitable mechanisms 506 may include, but are not limited to, diaphragms, pistons, sliding cylinder arrangements, and pistons within cylinders.

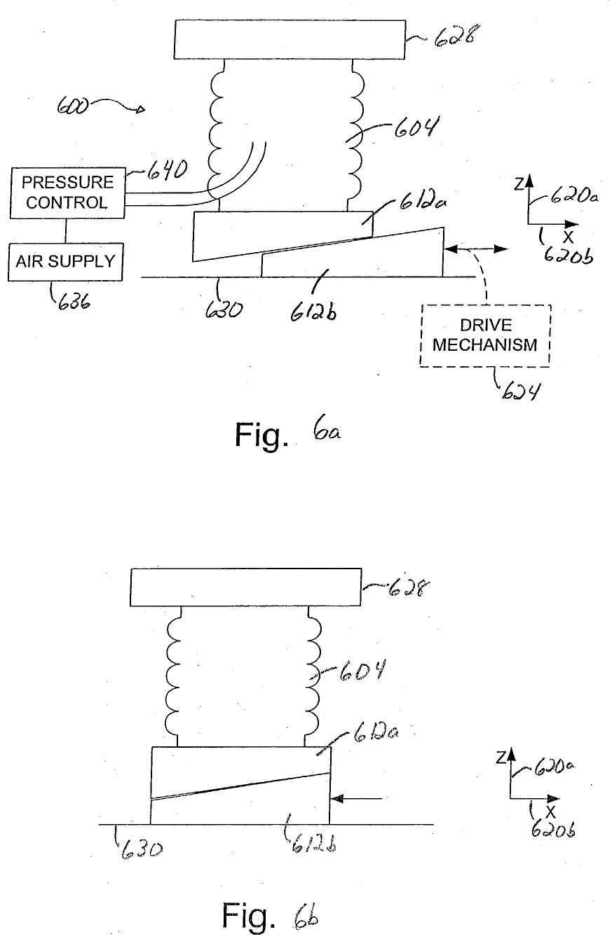

As discussed above, a length-adjustable bellows assembly which includes two bellows coupled by an adjusting plate such as bellows assembly 300 of FIG. 3a is well-suited for use when a load supported on the bellows assembly is relatively large. Although such a bellows assembly is also suitable for use when a load supported on the bellows assembly is relatively small, e.g., in the range of up to approximately six kilograms, bellows assemblies which are relatively less complex may be used when the load to be supported is relatively small. With reference to FIGS. 6a and 6b, a length-adjustable bellows assembly which is suitable for use in supporting relatively small loads will be described in accordance with an embodiment of the present invention. A bellows assembly 600 includes a bellows 604, a top wedge 612a, and a bottom wedge 612b. Bellows 604 is coupled or otherwise attached to a load 628 at one end such that bellows 604 supports load 628.

When the lateral stiffness of bellows 604 is to be adjusted, a drive mechanism 624 may drive bottom wedge 612b between a ground surface 630 and top wedge 612a in an x-direction 620b. It should be appreciated that since bellows supports load 628, drive mechanism 624 effectively drives substantially the entire load 628. Hence, load 628 is preferably relatively light. Driving bottom wedge 612b in a negative x-direction 620b may enable bellows 604 to be compressed in a z-direction 620a, as shown in FIG. 6b. In order to decompress or extend bellows 604, drive mechanism 624 may drive wedge in a positive x-direction 620b. Generally, extending bellows 604 in a z-direction 620a allows the lateral stiffness of bellows 604 to be increased, if the position with respect to z-direction 620a of load 628 remains substantially unchanged. Adjusting the internal air pressure of bellows 604 enables a top of bellows 604 to effectively move up or down with respect to z-direction 620a and, hence, maintain or otherwise achieve a desired position of load 628 with respect to z-direction 620a. The internal air pressure of the bellows may be adjusted by controlling the air provided by an air supply 636 through a pressure control 640 to bellows 604.

In one embodiment, drive mechanism 624 may include a locking feature which effectively enables bottom wedge 612b to be locked with respect to top wedge 612a such that a desired length of bellows 604 may be maintained. Alternatively, bottom wedge 612b may be coupled to a locking mechanism (not shown) which enables a desired position of bottom wedge 612b, i.e., a position of bottom wedge 612b which achieves a desired length of bellows 604, to be maintained when the locking mechanism is engaged. When it is desired to drive bottom wedge 612b to another position with respect to x-direction 620b, then such a locking mechanism (not shown) may be disengaged.

Top wedge 612a and bottom wedge 612b cooperate, along with drive mechanism 624, to serve as a length or height adjustment mechanism. In general, a mechanism that is suitable for adjusting the length of bellows 604 with respect to z-direction 620a may be substantially any suitable mechanism. That is, although the use of wedges 612 in conjunction with drive mechanism 624 as a wedge drive is one example of a mechanism which enables the length of bellows 604 to be altered to alter the lateral stiffness associated with bellows 604, other mechanism which enable the length of bellows 604 to be altered may instead be used.

The lateral stiffness of bellows 604 may be adjusted when load 628 and bellows assembly 600 are first installed or otherwise positioned in a desired location. By way of example, the lateral stiffness of bellows 604 may effectively be calibrated when load 628 and bellows assembly 600 are first set up for use. In other words, the lateral stiffness of bellows 604 may be statically adjusted. Additionally, readjustments to the lateral stiffness of bellows 604 may be made at some point after load 628 and bellows assembly 600 have been in use and, hence, after the lateral stiffness of bellows 604 has been initially calibrated. Such readjustments, or dynamic adjustments to the lateral stiffness, may be made in response to changes in the distribution of load 628, or changes in the environment in which bellows assembly 600 and load 604 are installed.

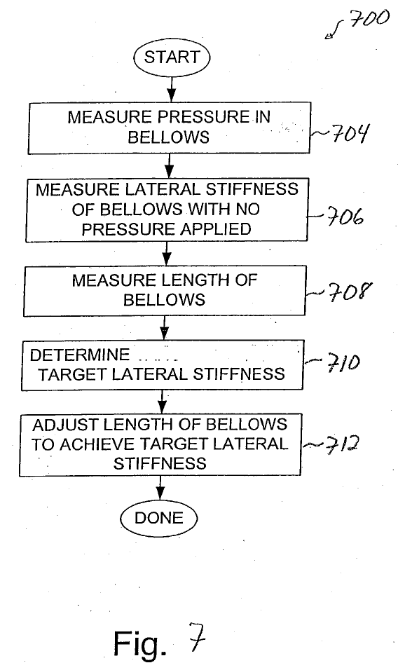

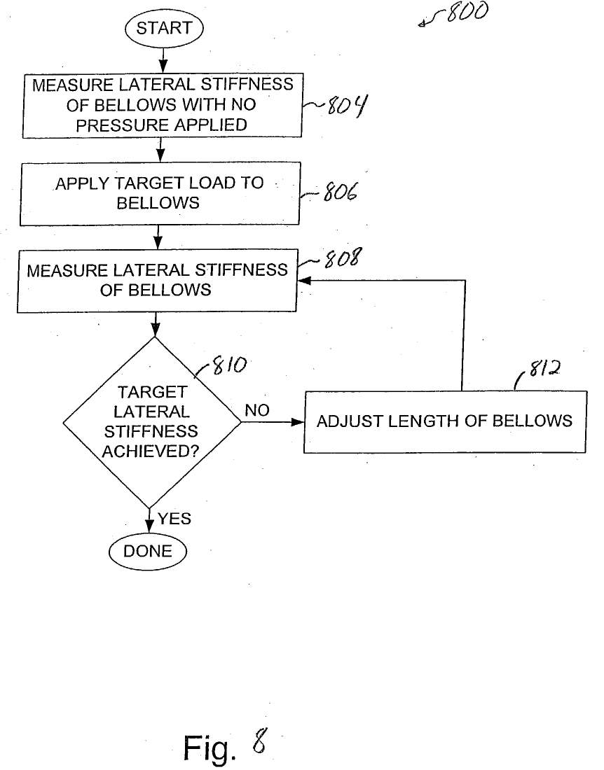

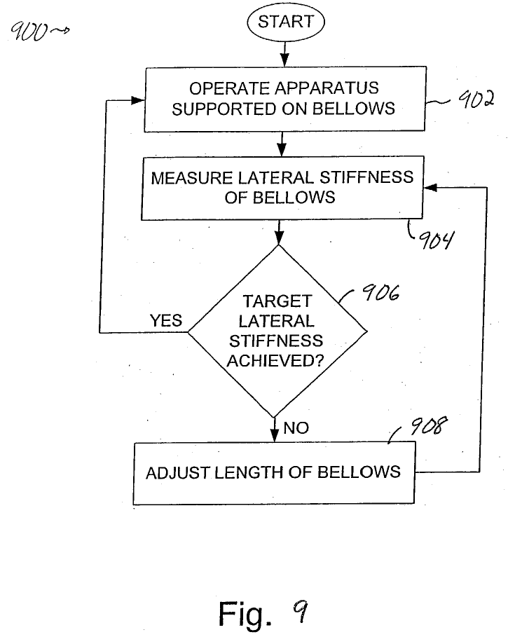

Referring next to FIG. 7, one method of adjusting the lateral stiffness of a bellows statically, as for example when a system which includes the bellows is first installed, will be described in accordance with an embodiment of the present invention. A process 700 of adjusting the lateral stiffness of a bellows begins at step 704 in which the air pressure in the bellows is measured. In one embodiment, measuring the air pressure in the bellows may include measuring or otherwise determining the magnitude of the load which will be supported or otherwise experienced by the bellows. Once the pressure in the bellows is measured, the lateral stiffness of the bellows with no pressure applied is measured or otherwise determined in step 706. The lateral stiffness of the bellows with no pressure applied may be determined, for example, through the use of standard beam equations which are well known to those skilled in the art, through specifications provided by the bellows manufacturer, or by experiment.

After the lateral stiffness of the bellows when no pressure is applied is determined, the current length of the bellows is measured in step 708. It should be appreciated that when the bellows is part of an assembly which includes a top bellows and a bottom bellows, e.g., as described above with respect to FIGS. 3a and 3b, the current length of the bellows that is measured is generally the current length of the top bellows. The target lateral stiffness is determined in step 710. Typically, determining the target lateral stiffness may include determining an appropriate, or acceptable, lateral stiffness for the pressure measured in step 704. Such a determination may be made through the use of a look-up table or similar data structure which may list target lateral stiffnesses for particular pressures or supported loads.

Once the target lateral stiffness is identified, the length of the bellows may be adjusted as appropriate to achieve the target lateral stiffness in step 712. That is, a suitable length for the bellows may be determined, and the bellows may be adjusted to the suitable length. In one embodiment, a suitable length may be determined through the use of an equation which defines a relationship between a target lateral stiffness, a lateral stiffness of the bellows when no pressure is applied to the bellows, a target load or pressure, and the length, e.g., the lateral stiffness equation discussed above with reference to FIG. 3a. The bellows may be adjusted using any appropriate drive mechanism. Appropriate drive mechanisms may include, but are not limited to, motors and lead screw arrangements. The process of statically adjusting the lateral stiffness of a bellows is completed once the length of the bellows is adjusted.

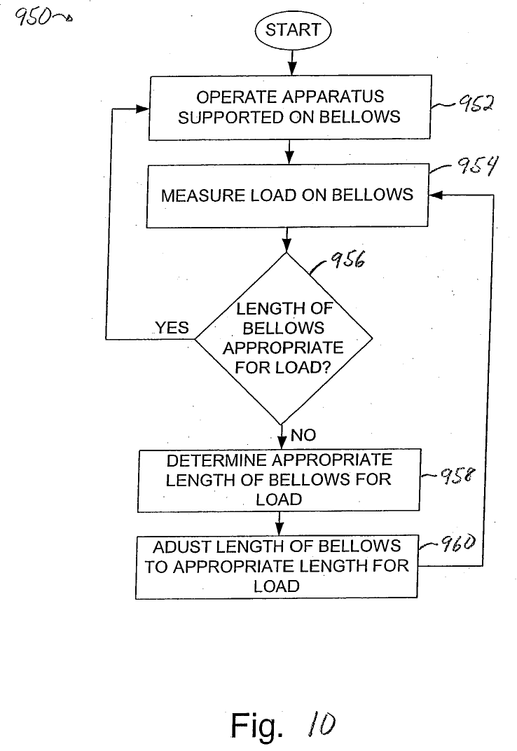

FIG. 8 is process flow diagram which illustrates the steps associated with a second method for statically adjusting the lateral stiffness of a bellows in accordance with an embodiment of the present invention. A process 800 of adjusting the lateral stiffness of a bellows begins at step 804 in which the lateral stiffness of the bellows is measured or determined using substantially any suitable method when no pressure or load is applied to the bellows. Once the lateral stiffness is determined, a target pressure or load is applied to the bellows in step 806. Applying a target load to the bellows generally includes allowing the bellows to support the load, e.g., the wafer table or exposure apparatus, which the bellows would support when the bellows is in use, and adjusting or altering an internal pressure of the bellows such that the load may be supported.

After the target load is applied to the bellows, the lateral stiffness of the bellows is measured in step 808. A determination is then made in step 810 regarding whether the target lateral stiffness, i.e., a lateral stiffness that is appropriate for reducing the transmissibility of vibrations through the bellows to an acceptable level when the target load is supported on the bellows, is achieved. If it is determined in step 810 that the target lateral stiffness is not achieved, then the indication is that the lateral stiffness of the bellows is too high and, hence, that vibration transmissibility is at a higher level than desired. Accordingly, process flow proceeds to step 812 in which the length of the bellows is adjusted. Once the length of the bellows is adjusted, process flow returns to step 808 in which the lateral stiffness of the bellows is remeasured.

Alternatively, if it is determined in step 810 that the target lateral stiffness in the bellows is achieved, the indication is that vibration transmissibility is at an acceptable level. That is, if the target lateral stiffness in the bellows is achieved, then either substantially no vibrations are transmitted through the bellows, or an insignificant amount of vibrations are transmitted through the bellows. As such, the process of adjusting the lateral stiffness of a bellows is completed.

In some embodiments, it may be desirable to allow the lateral stiffness of a bellows to be adjusted dynamically, or at some point after the apparatus supported on the bellows and, hence, the bellows are in use. Allowing the lateral stiffness of a bellows to be adjusted dynamically enables substantially any changes to the load supported by the bellows to be relatively efficiently compensated for. Referring next to FIG. 9, one method of dynamically adjusting the lateral stiffness of a bellows will be described in accordance with an embodiment of the present invention. A process 900 of dynamically adjusting the lateral stiffness of a bellows begins at step 902 in which an apparatus, e.g., a wafer table, supported on the bellows operates. By way of example, if the apparatus is a wafer table, the apparatus may scan a wafer as a part of a wafer exposure process.

Periodically, while the apparatus supported on the bellows is in operation, the lateral stiffness of the bellows may effectively be measured in step 904. Once the lateral stiffness of the bellows is measured, a determination is made in step 906 as to whether the measured lateral stiffness is approximately equal to, or is less than, a target lateral stiffness. That is, it is determined in step 906 whether the measured lateral stiffness is suitable for achieving a desired level of vibration transmissibility. If it is determined in step 906 that the target lateral stiffness has been achieved, then the indication is that the current lateral stiffness of the bellows is at an acceptable level. Accordingly, process flow returns to step 902 in which the apparatus supported on the bellows continues to operate.

Alternatively, if it is determined in step 906 that the target lateral stiffness is not achieved, then the length of the bellows may be adjusted in step 908. Adjusting the length of the bellows may effectively involve setting the length of the bellows to a length which typically enables the desired target lateral stiffness to be achieved given the load on the bellows, in the event that the load is known. On the other hand, adjusting the length of the bellows may include making incremental adjustments to the length until it is determined that a target lateral stiffness is achieved. After the length of the bellows is adjusted, the lateral stiffness of the bellows may be measured in step 904.

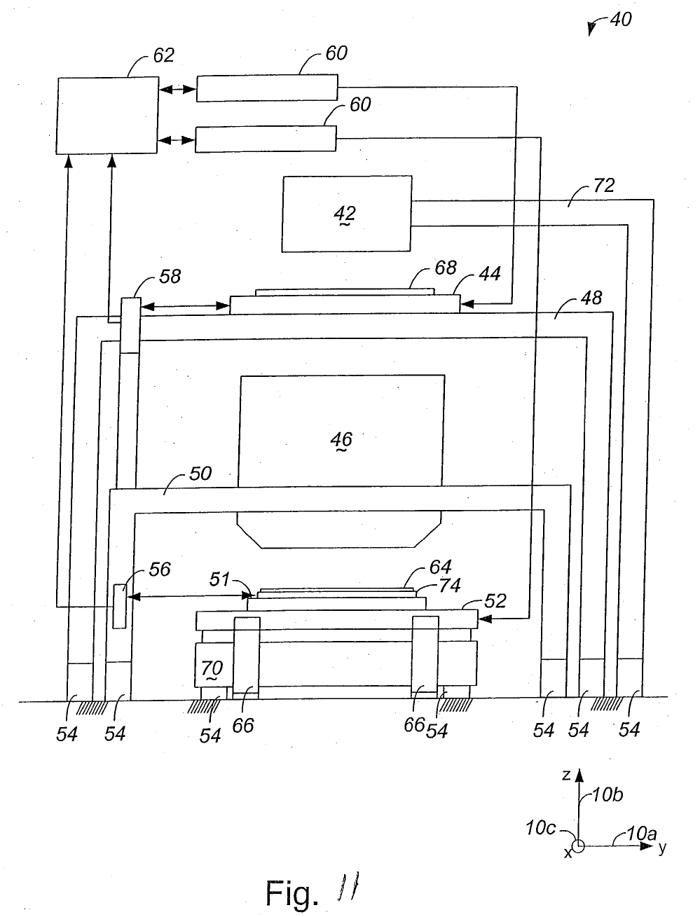

Methods for dynamically adjusting the lateral stiffness of a bellows may differ. By way of example, rather than measuring or otherwise determining the lateral stiffness of the bellows then adjusting the length of the bellows, methods for dynamically adjusting the lateral stiffness of the bellows may instead include determining the load on the bellows and the length of the bellows before adjusting the length to a length that is suitable for supporting the load with minimal vibration transmissibility. FIG. 10 is a process flow diagram which illustrates the steps associated with a method of dynamically adjusting the lateral stiffness of a bellows which includes measuring a load on the bellows in accordance with an embodiment of the present invention. A process 950 of dynamically adjusting the lateral stiffness of a bellows begins at step 952 in which the apparatus supported on the bellows is allowed to operate. While the apparatus operates, the load on the bellows may be measured in step 954. The load may be measured periodically at substantially random times, or the load may be measured periodically at substantially regular intervals.

A determination is made in step 956 as to whether the length of the bellows is appropriate for the load on the bellows. Such a determination may generally involve measuring the current length of the bellows if the current length is not known. If it is determined that the length of the bellows is appropriate for the load, then the implication is that the length of the bellows allows the lateral stiffness of the bellows to be low enough that the vibration transmissibility through the bellows is acceptable. As such, process flow moves from step 956 back to step 952 in which the apparatus continues to operate.

Alternatively, if it is determined in step 956 that the length of the bellows is not appropriate for the load, then the indication is that the lateral stiffness associated with the length is not low enough for the vibration transmissibility associated with the bellows to be considered as acceptable. Hence, in step 958, a length for the bellows that is appropriate for the load on the bellows is determined. Such a determination may be made using substantially any suitable method. For example, a suitable length for the bellows may be determined through the use of a look-up table which correlates loads with target lengths. Once an appropriate length for the bellows is determined, the length of the bellows is adjusted in step 960, i.e., to approximately the appropriate length determined in step 958. After the length of the bellows is adjusted, process flow returns to step 954 in which the load on the bellows is once again measured.

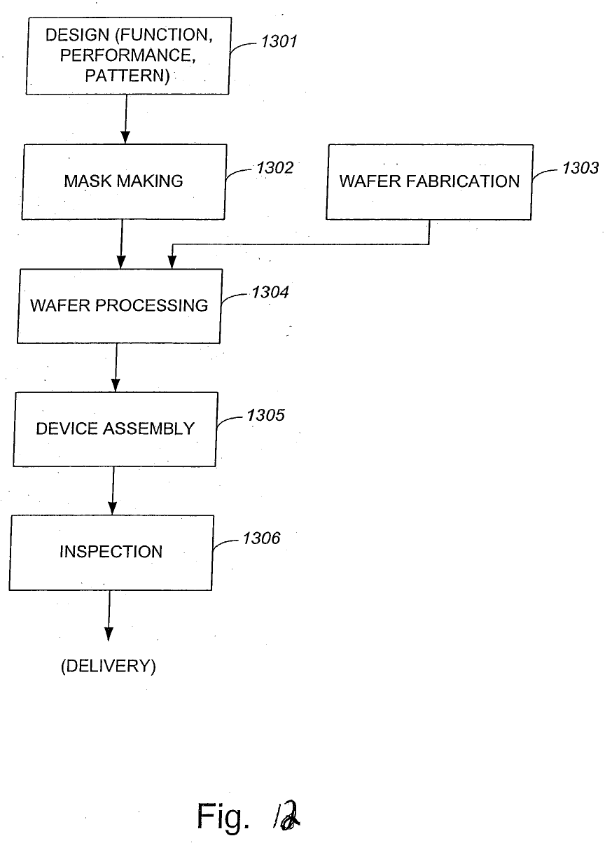

With reference to FIG. 11, a photolithography apparatus which may include a length-adjustable bellows will be described in accordance with an embodiment of the present invention. A photolithography apparatus (exposure apparatus) 40 includes a wafer positioning stage 52 that may be driven by a planar motor (not shown), as well as a wafer table 51 that is magnetically coupled to wafer positioning stage 52 by utilizing an EI-core actuator, e.g., an El-core actuator with a top coil and a bottom coil which are substantially independently controlled. The planar motor which drives wafer positioning stage 52 generally uses an electromagnetic force generated by magnets and corresponding armature coils arranged in two dimensions. A wafer 64 is held in place on a wafer holder or chuck 74 which is coupled to wafer table 51. Wafer positioning stage 52 is arranged to move in multiple degrees of freedom, e.g., between three to six degrees of freedom, under the control of a control unit 60 and a system controller 62. The movement of wafer positioning stage 52 allows wafer 64 to be positioned at a desired position and orientation relative to a projection optical system 46.

Wafer table 51 may be levitated in a z-direction 10b by any number of voice coil motors (not shown), e.g., three voice coil motors. In the described embodiment, at least three magnetic bearings (not shown) couple and move wafer table 51 along a y-axis 10a. The motor array of wafer positioning stage 52 is typically supported by a base 70. Base 70 is supported to a ground via isolators 54. Reaction forces generated by motion of wafer stage 52 may be mechanically released to a ground surface through a frame 66. One suitable frame 66 is described in JP Hei 8-166475 and U.S. Pat. No. 5,528,118, which are each herein incorporated by reference in their entireties.

An illumination system 42 is supported by a frame 72. Frame 72 is supported to the ground via isolators 54. Illumination system 42 includes an illumination source, and is arranged to project a radiant energy, e.g., light, through a mask pattern on a reticle 68 that is supported by and scanned using a reticle stage which includes a coarse stage and a fine stage. The radiant energy is focused through projection optical system 46, which is supported on a projection optics frame 50 and may be supported the ground through isolators 54. Suitable isolators 54 include those described in JP Hei 8-330224 and U.S. Pat. No. 5,874,820, which are each incorporated herein by reference in their entireties. Isolators 54 may also be length-adjustable bellows and, further, may be part of an overall active vibration isolation system (AVIS), as will be discussed below.

A first interferometer 56 is supported on projection optics frame 50, and functions to detect the position of wafer table 51. Interferometer 56 outputs information on the position of wafer table 51 to system controller 62. In one embodiment, wafer table 51 has a force damper which reduces vibrations associated with wafer table 51 such that interferometer 56 may accurately detect the position of wafer table 51. A second interferometer 58 is supported on projection optical system 46, and detects the position of reticle stage 44 which supports a reticle 68. Reticle stage 44 is supported on a reticle stage frame 48 and may be supported to the ground through isolators 54. Interferometer 58 also outputs position information to system controller 62.

It should be appreciated that there are a number of different types of photolithographic apparatuses or devices. For example, photolithography apparatus 40, or an exposure apparatus, may be used as a scanning type photolithography system which exposes the pattern from reticle 68 onto wafer 64 with reticle 68 and wafer 64 moving substantially synchronously. In a scanning type lithographic device, reticle 68 is moved perpendicularly with respect to an optical axis of a lens assembly (projection optical system 46) or illumination system 42 by reticle stage 44. Wafer 64 is moved perpendicularly to the optical axis of projection optical system 46 by a wafer stage 52. Scanning of reticle 68 and wafer 64 generally occurs while reticle 68 and wafer 64 are moving substantially synchronously.

Alternatively, photolithography apparatus or exposure apparatus 40 may be a step-and-repeat type photolithography system that exposes reticle 68 while reticle 68 and wafer 64 are stationary, i. e., at a substantially constant velocity of approximately zero meters per second. In one step and repeat process, wafer 64 is in a substantially constant position relative to reticle 68 and projection optical system 46 during the exposure of an individual field. Subsequently, between consecutive exposure steps, wafer 64 is consecutively moved by wafer positioning stage 52 perpendicularly to the optical axis of projection optical system 46 and reticle 68 for exposure. Following this process, the images on reticle 68 may be sequentially exposed onto the fields of wafer 64 so that the next field of semiconductor wafer 64 is brought into position relative to illumination system 42, reticle 68, and projection optical system 46.

It should be understood that the use of photolithography apparatus or exposure apparatus 40, as described above, is not limited to being used in a photolithography system for semiconductor manufacturing. For example, photolithography apparatus 40 may be used as a part of a liquid crystal display (LCD) photolithography system that exposes an LCD device pattern onto a rectangular glass plate or a photolithography system for manufacturing a thin film magnetic head.

The illumination source of illumination system 42 may be g-line (436 nanometers (nm)), i-line (365 nm), a KrF excimer laser (248 nm), an ArF excimer laser (193 nm), and an F₂-type laser (157 nm). Alternatively, illumination system 42 may also use charged particle beams such as x-ray and electron beams. For instance, in the case where an electron beam is used, thermionic emission type lanthanum hexaboride (LaB₆) or tantalum (Ta) may be used as an electron gun. Furthermore, in the case where an electron beam is used, the structure may be such that either a mask is used or a pattern may be directly formed on a substrate without the use of a mask.

With respect to projection optical system 46, when far ultra-violet rays such as an excimer laser is used, glass materials such as quartz and fluorite that transmit far ultra-violet rays is preferably used. When either an F₂-type laser or an x-ray is used, projection optical system 46 may be either catadioptric or refractive (a reticle may be of a corresponding reflective type), and when an electron beam is used, electron optics may comprise electron lenses and deflectors. As will be appreciated by those skilled in the art, the optical path for the electron beams is generally in a vacuum.

In addition, with an exposure device that employs vacuum ultra-violet (VUV) radiation of a wavelength that is approximately 200 nm or lower, use of a catadioptric type optical system may be considered. Examples of a catadioptric type of optical system include, but are not limited to, those described in Japan Patent Application Disclosure No. 8-171054 published in the Official gazette for Laid-Open Patent Applications and its counterpart U.S. Pat. No. 5,668,672, as well as in Japan Patent Application Disclosure No. 10-20195 and its counterpart U.S. Pat. No. 5,835,275, which are all incorporated herein by reference in their entireties. In these examples, the reflecting optical device may be a catadioptric optical system incorporating a beam splitter and a concave mirror. Japan Patent Application Disclosure (Hei) No. 8-334695 published in the Official gazette for Laid-Open Patent Applications and its counterpart U.S. Pat. No. 5,689,377, as well as Japan Patent Application Disclosure No. 10-3039 and its counterpart U.S. Pat. No. 5,892,117, which are all incorporated herein by reference in their entireties. These examples describe a reflecting-refracting type of optical system that incorporates a concave mirror, but without a beam splitter, and may also be suitable for use with the present invention.

Further, in photolithography systems, when linear motors (see U.S. Pat. Nos. 5,623,853 or 5,528,118, which are each incorporated herein by reference in their entireties) are used in a wafer stage or a reticle stage, the linear motors may be either an air levitation type that employs air bearings or a magnetic levitation type that uses Lorentz forces or reactance forces. Additionally, the stage may also move along a guide, or may be a guideless type stage which uses no guide.

Alternatively, a wafer stage or a reticle stage may be driven by a planar motor which drives a stage through the use of electromagnetic forces generated by a magnet unit that has magnets arranged in two dimensions and an armature coil unit that has coil in facing positions in two dimensions. With this type of drive system, one of the magnet unit or the armature coil unit is connected to the stage, while the other is mounted on the moving plane side of the stage.

Movement of the stages as described above generates reaction forces which may affect performance of an overall photolithography system. Reaction forces generated by the wafer (substrate) stage motion may be mechanically released to the floor or ground by use of a frame member as described above, as well as in U.S. Pat. No. 5,528,118 and published Japanese Patent Application Disclosure No. 8-166475. Additionally, reaction forces generated by the reticle (mask) stage motion may be mechanically released to the floor (ground) by use of a frame member as described in U.S. Pat. No. 5,874,820 and published Japanese Patent Application Disclosure No. 8-330224, which are each incorporated herein by reference in their entireties.

Isolaters such as isolators 54 may generally be associated with an AVIS, as previously mentioned. An AVIS generally controls vibrations associated with forces 112, i.e., vibrational forces, which are experienced by a stage assembly or, more generally, by a photolithography machine such as photolithography apparatus 40 which includes a stage assembly. In one embodiment, at least some of isolators 54 may be length-adjustable bellows, or, more specifically, bellows with lateral stiffness adjustment capabilities.

A photolithography system according to the above-described embodiments, e.g., a photolithography apparatus which may include one or more dual force actuators, may be built by assembling various subsystems in such a manner that prescribed mechanical accuracy, electrical accuracy, and optical accuracy are maintained. In order to maintain the various accuracies, prior to and following assembly, substantially every optical system may be adjusted to achieve its optical accuracy. Similarly, substantially every mechanical system and substantially every electrical system may be adjusted to achieve their respective desired mechanical and electrical accuracies. The process of assembling each subsystem into a photolithography system includes, but is not limited to, developing mechanical interfaces, electrical circuit wiring connections, and air pressure plumbing connections between each subsystem. There is also a process where each subsystem is assembled prior to assembling a photolithography system from the various subsystems. Once a photolithography system is assembled using the various subsystems, an overall adjustment is generally performed to ensure that substantially every desired accuracy is maintained within the overall photolithography system. Additionally, it may be desirable to manufacture an exposure system in a clean room where the temperature and humidity are controlled.

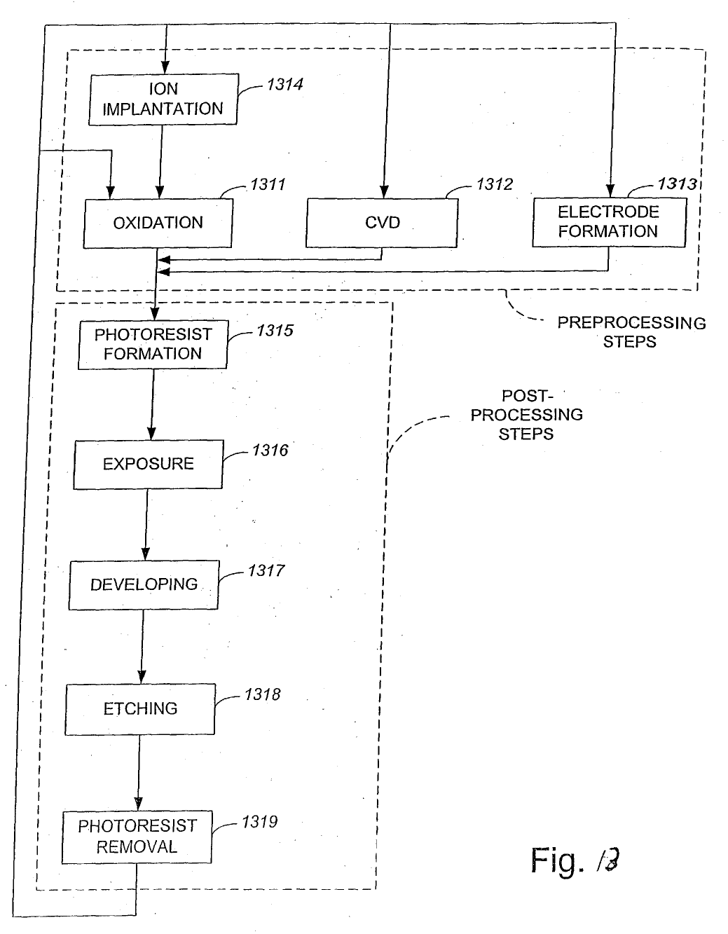

Further, semiconductor devices may be fabricated using systems described above, as will be discussed with reference to FIG. 12. The process begins at step 1301 in which the function and performance characteristics of a semiconductor device are designed or otherwise determined. Next, in step 1302, a reticle (mask) in which has a pattern is designed based upon the design of the semiconductor device. It should be appreciated that in a parallel step 1303, a wafer is made from a silicon material. The mask pattern designed in step 1302 is exposed onto the wafer fabricated in step 1303 in step 1304 by a photolithography system. One process of exposing a mask pattern onto a wafer will be described below with respect to FIG. 13. In step 1305, the semiconductor device is assembled. The assembly of the semiconductor device generally includes, but is not limited to, wafer dicing processes, bonding processes, and packaging processes. Finally, the completed device is inspected in step 1306.

FIG. 13 is a process flow diagram which illustrates the steps associated with wafer processing in the case of fabricating semiconductor devices in accordance with an embodiment of the present invention. In step 1311, the surface of a wafer is oxidized. Then, in step 1312 which is a chemical vapor deposition (CVD) step, an insulation film may be formed on the wafer surface. Once the insulation film is formed, in step 1313, electrodes are formed on the wafer by vapor deposition. Then, ions may be implanted in the wafer using substantially any suitable method in step 1314. As will be appreciated by those skilled in the art, steps 1311-1314 are generally considered to be preprocessing steps for wafers during wafer processing. Further, it should be understood that selections made in each step, e.g., the concentration of various chemicals to use in forming an insulation film in step 1312, may be made based upon processing requirements.

At each stage of wafer processing, when preprocessing steps have been completed, post-processing steps may be implemented. During post-processing, initially, in step 1315, photoresist is applied to a wafer. Then, in step 1316, an exposure device may be used to transfer the circuit pattern of a reticle to a wafer. Transferring the circuit pattern of the reticle of the wafer generally includes scanning a reticle scanning stage which may, in one embodiment, include a force damper to dampen vibrations.

After the circuit pattern on a reticle is transferred to a wafer, the exposed wafer is developed in step 1317. Once the exposed wafer is developed, parts other than residual photoresist, e.g., the exposed material surface, may be removed by etching. Finally, in step 1319, any unnecessary photoresist that remains after etching may be removed. As will be appreciated by those skilled in the art, multiple circuit patterns may be formed through the repetition of the preprocessing and post-processing steps.

Although only a few embodiments of the present invention have been described, it should be understood that the present invention may be embodied in many other specific forms without departing from the spirit or the scope of the present invention. By way of example, in lieu of adjusting the length or the height of a bellows in order to alter the lateral stiffness of the bellows, the internal pressure of the bellows may instead be adjusted to alter the lateral stiffness of the bellows. Alternatively, both the internal pressure of the bellows and the length of the bellows may be adjusted to alter the lateral stiffness of the bellows. It should be understood that although adjusting the mechanical stiffness of a bellows may be difficult, the mechanical stiffness of the bellows may also be adjusted either in lieu of or in conjunction with the length of the bellows or the internal pressure of the bellows to alter the lateral stiffness of the bellows.

While a plurality of bellows coupled to an adjusting plate within a bellows assembly has generally been described may have substantially the same characteristics, e.g., be made from the same material or have substantially the same dimensions and mechanical stiffness, the plurality of bellows within a bellows assembly may have different characteristics. In other words, the bellows included in a bellows assembly are not necessarily the same.

In general, the steps associated with the methods of the present invention may vary widely. Steps may be added, removed, altered, and reordered. By way of example, instead of determining a target lateral stiffness during a process for achieving a target lateral stiffness, a target bellows length may instead be determined without departing from the spirit or the scope of the present invention. Therefore, the present examples are to be considered as illustrative and not restrictive, and the invention is not to be limited to the details given herein, but may be modified within the scope of the appended claims.

What is claimed is:

1. A bellows assembly, the bellows assembly being arranged to support a load, the bellows assembly comprising:
a first bellows, the first bellows having an adjustable length, the first bellows having a first end and a second end, wherein the first end of the first bellows is arranged to be coupled to the load; and
a mechanism, the mechanism being arranged to substantially adjust the length of the first bellows, wherein the second end of the first bellows is arranged to be coupled to the mechanism.

2. The bellows assembly of claim 1 wherein the bellows assembly further includes a second bellows, the second bellows having a first end and a second end, the first end being arranged to be coupled to the mechanism and the second end being arranged to be coupled to a ground surface.

3. The bellows assembly of claim 2 wherein the mechanism includes a plate and a driver, the plate being arranged to be coupled to the second end of the first bellows and the first end of the second bellows, the driver being arranged to substantially drive the plate to adjust the length of the first bellows.

4. The bellows assembly of claim 1 wherein the bellows assembly further includes a vertically adjustable mechanism, the vertically adjustable mechanism having a first surface and a second surface, the first surface being arranged to be coupled to the mechanism and the second surface being arranged to be in contact with a ground surface.

5. The bellows assembly of claim 4 wherein the mechanism includes a plate and a driver, the plate being arranged to be coupled to the second end of the first bellows and the first surface of the vertically adjustable mechanism, the driver being arranged to substantially drive the plate to adjust the length of the first bellows.

6. The bellows assembly of claim 1 wherein the mechanism includes a first block and a second block, the first block being arranged to be coupled to the second end of the first bellows, the second block being arranged to be in contact with a ground surface.

7. The bellows assembly of claim 6 wherein the mechanism further includes a drive mechanism, the drive mechanism being arranged to drive the second block substantially between the ground and the first block to alter the length of the first bellows.

8. The bellows assembly of claim 7 further including:
an air supply inlet, the air supply inlet being arranged to receive air that alters an air pressure within the first bellows, wherein the air pressure is arranged to be altered to maintain the first end of the first bellows at a first position when the length of the first bellows is altered.

9. The bellows assembly of claim 1 further including:
an air supply inlet, the air supply inlet being arranged to receive air that alters an air pressure within the first bellows, wherein the air pressure is arranged to be altered to maintain the first end of the first bellows at a first position when the length of the first bellows is altered.

10. The bellows assembly of claim 1 wherein the load includes a wafer table.

11. An exposure apparatus comprising the bellows assembly of claim 10.

12. A device manufactured with the exposure apparatus of claim 11.

13. A wafer on which an image has been formed by the exposure apparatus of claim 11.

14. A bellows assembly, the bellows assembly being arranged to support a load, the bellows assembly comprising:
a first bellows, the first bellows having an adjustable lateral stiffness, the first bellows having a first end, wherein the first end of the first bellows is arranged to be coupled to the load; and
a mechanism, the mechanism being arranged to substantially adjust the lateral stiffness of the first bellows, wherein the first bellows is arranged to be coupled to the mechanism.

15. The bellows assembly of claim 14 wherein the bellows assembly further includes a second bellows, the second bellows having a first end and a second end, the first end being arranged to be coupled to the mechanism and the second end being arranged to be coupled to a ground surface, and wherein the mechanism includes a plate and a driver, the plate being arranged to be coupled to a second end of the first bellows and the first end of the second bellows, the driver being arranged to substantially drive the plate to adjust the lateral stiffness of the first bellows.

16. The bellows assembly of claim 14 wherein the bellows assembly further includes a vertically adjustable mechanism, the vertically adjustable mechanism having a first surface and a second surface, the first surface being arranged to be coupled to the mechanism and the second surface being arranged to be in contact with a ground surface, and wherein the mechanism includes a plate and a driver, the plate being arranged to be coupled to a second end of the first bellows and the first surface of the second bellows, the driver being arranged to substantially drive the plate to adjust the lateral stiffness of the first bellows.

17. The bellows assembly of claim 14 wherein the mechanism includes a first block and a second block, the first block being arranged to be coupled to the second end of the first bellows, the second block being arranged to be in contact with a ground surface, and wherein the mechanism further includes a drive mechanism, the drive mechanism being arranged to drive the second block substantially between the ground surface and the first block to alter the lateral stiffness of the first bellows.

18. The bellows assembly of claim 17 further including:
an air supply inlet, the air supply inlet being arranged to receive air that alters an air pressure within the first bellows, wherein the air pressure is arranged to be altered to maintain the first end of the first bellows at a first position when the lateral stiffness of the first bellows is altered.

19. The bellows assembly of claim 14 wherein the mechanism is arranged to adjust the lateral stiffness of the first bellows by altering at least one of a mechanical stiffness of the first bellows, an internal pressure of the first bellows, and a length of the first bellows.

20. The bellows assembly of claim 14 further including:
an air supply inlet, the air supply inlet being arranged to receive air that alters an air pressure within the first bellows, wherein the air pressure is arranged to be altered to maintain the first end of the first bellows at a first position when the lateral stiffness of the first bellows is altered.

21. The bellows assembly of claim 14 wherein the load includes a wafer table.

22. An exposure apparatus comprising the bellows assembly of claim 21.

23. A device manufactured with the exposure apparatus of claim 22.

24. A wafer on which an image has been formed by the exposure apparatus of claim 22.

25. A method for adjusting a lateral stiffness of a bellows assembly, the bellows assembly being arranged to substantially vibrationally isolate a load from a first surface, the bellows assembly including a first bellows and a mechanism arranged to adjust the lateral stiffness of the first bellows, the method comprising:
identifying the lateral stiffness of a first bellows;
determining when the lateral stiffness of the first bellows is acceptable; and
adjusting the lateral stiffness of the first bellows using the mechanism when it is determined that the lateral stiffness of the first bellows is not acceptable.

26. The method of claim 25 wherein adjusting the lateral stiffness of the first bellows includes adjusting a length of the first bellows between the load and the first surface.

27. The method of claim 25 wherein adjusting the lateral stiffness of the bellows includes adjusting an internal pressure of the bellows.

28. The method of claim 25 wherein adjusting the lateral stiffness of the bellows includes adjusting a mechanical stiffness of the bellows.

29. The method of claim 25 wherein determining when the lateral stiffness of the first bellows is acceptable includes determining when a length of the first bellows between the load and the first surface is acceptable.

30. The method of claim 25 wherein determining when the lateral stiffness of the first bellows is acceptable includes determining when the lateral stiffness of the first bellows is associated with an acceptable level of vibration transmissibility from the first surface through the first bellows to the load.

31. The method of claim 25 wherein the mechanism includes a second surface and a driver, the second surface being coupled to the first bellows, the driver being arranged to drive the second surface, and wherein adjusting the lateral stiffness of the first bellows includes driving the second surface to reduce a length of the first bellows.

32. The method of claim 25 wherein determining when the lateral stiffness of the first bellows is acceptable includes determining when the lateral stiffness of the first bellows is too high.

33. The method of claim 32 wherein when it is determined that the lateral stiffness of the first bellows is too high, adjusting-the lateral stiffness of the first bellows using the mechanism includes reducing the lateral stiffness of the first bellows.

34. A method for operating an exposure apparatus comprising the method for adjusting of claim 25.

35. A method for making an object including at least a photolithography process wherein the photolithography process utilizes the method of operating an exposure apparatus of claim 34.

36. A method for making a wafer utilizing the method of operating an exposure apparatus of claim 34.
